(19) United States
(12) Patent Application Publication
(10) Pub. No.: US 2014/0006167 A1
(43) Pub. Date: Jan. 2, 2014

(54) SYSTEMS AND METHODS FOR INTEGRATING ADVERTISEMENTS WITH MESSAGES IN MOBILE COMMUNICATION DEVICES

(71) Applicant: Talkler Labs, LLC, Belmont, MA (US)

(72) Inventor: Jeffrey Korn, Belmont, MA (US)

(73) Assignee: Talkler Labs, LLC, Belmont, MA (US)

(21) Appl. No.: 13/930,543

(22) Filed: Jun. 28, 2013

Related U.S. Application Data
(60) Provisional application No. 61/665,737, filed on Jun. 28, 2012.

(51) Int. Cl. G06Q 30/02

(52) U.S. Cl. CPC G06Q 30/0267
USPC 705/14.64

(57) ABSTRACT

Embodiments of the invention provide methods and systems for presenting an audible representation of an advertising message delivered onto a mobile device. An electronic message is received at a mobile device. The message has textual content and at least one topic component. The textual content is translated into an audio stream and the topic component is identified from the message. Advertisements having the same or similar topic components as the topic component extracted from the message are identified and interjected into the audible representation of the message. The advertisement and the message emanate from different sources.

### CROSS-REFERENCE TO RELATED APPLICATIONS

This application claims priority to and the full benefit of U.S. Provisional Patent Application No. 61/665,737, filed on Jun. 28, 2012, the disclosure of which is incorporated by reference in its entirety.

### FIELD OF THE INVENTION

This invention relates generally to delivery of electronic advertising content, and, more specifically, techniques and supporting systems for integrating advertising matter into messages received at a mobile communication device.

### BACKGROUND

Mobile devices have become ubiquitous in the everyday life of the general consumer. No longer are cellular phones, electronic personal data assistants, and Internet-connected hand-held devices reserved for the elite. As these devices become ingrained in consumers' daily routines, advertising entities (e.g., brands, marketers, advertising networks, etc.) have recognized a new medium for delivery of context-relevant ads. Because of the amount and type of data known about that consumer at a very specific time, ads can be targeted directly to a user based, for example, on their current location, proximity to a particular store, and other attributes.

However, consumers still spend the majority of their time using these devices to send and receive messages from friends and coworkers. Receiving separate ads (usually in the form of spam emails or text messages, or “in-app” advertising acts as more of an annoyance, and are easily dismissed. Still, advertisers invest heavily in advertising to deliver their messages to target audiences but according to recent surveys and studies over half of all mobile advertising is never viewed, heard or attended to by the target audience. Even conventional audible advertisements (e.g., radio ads) are too easy for listeners to “tune out,” disregard or change the station, in the same way that the music and other audio content surrounding an audio ad is likewise easy to “tune out.” However, content directed at the listener (e.g., their own email or messages) are much less likely to be ignored or skipped. Further, ads delivered via mobile are monetized based on click-throughs and other user-initiated events, which, in certain circumstances such as during driving are not safe or reasonable to expect a consumer to perform.

What is needed, therefore, is a technique and supporting system for integrating advertisements directly into messages that listeners will listen to and does not require user actions to deliver.

### SUMMARY OF THE INVENTION

The disclosed method comprises a Software Application that functions in conjunction with a speech recognizer to enable a user to listen to and interact with the mobile communication device using primarily his or her voice, in an essentially hands-free and eyes-free manner. The Software Application also functions to seamlessly integrate the playback of advertisement audio clips with received messages.

One conventional and popular method of advertisement delivery via a mobile communication device is onscreen textual and graphic advertising. Such onscreen advertising is not effective for a mobile software application, unless the user views the device screen. Accordingly, such software applications do not successfully deliver onscreen advertisements to a mobile device user who prefers not to view the device screen.

Another method of advertising matter delivery is audible advertising, similar to advertisements played on a radio station. However, such audible advertisements are easy for the user to “tune out” or disregard, in the same way that the music or other audio content surrounding the audible advertisement can be likewise “tuned out.” The present invention discloses a software application that functions in an “eyes-free” environment, in such a way that a user finds it difficult to “tune out” advertising matter. It can be appreciated that advertisers invest heavily in advertising to deliver their messages to target audiences, and the disclosed method functions to insure that such advertising messages are not likely to be ignored by an intended recipient.

Therefore, in a first aspect, a method for presenting an audible representation of an advertising message delivered onto a mobile device includes receiving an incoming electronic message having textual content and a topic component. The text is translated into an audio stream, and the topic component is identified and/or electronically extracted from the text. In some cases, the ads are specifically designed to support this technique and metadata is attributed to the advertisements that specifies the topic component. Advertisements, stored in an electronic storage device and coming from a source other than the electronic message (e.g., are not simply responses from the originator of the message itself), are identified as having a matching (or nearly matching) topic component. This allows an advertiser to target an ad based on the content of the message. An audible representation of the advertising message is inserted into the audio stream of the incoming electronic message, or, in some cases, shortly before or after the incoming electronic message, such that the relevance of the targeted ad is not lost on the user.

The electronic message can be an electronic mail message or a text message, a news stream or SMS message, a calendar event, a document, or any structured content, and the topic can be any topic within a message, such as a geographical area, an activity, a product, a product class, keywords, or a service. In some embodiments, an introductory message may be inserted into the audible representation of the advertising message. The tone and voice of the speech used to convey the advertisement may be the same as that of the electronic message itself, such that the user is less likely to notice a difference between the message and the advertisement, or “tune out” the advertising message. Or, in some cases, the voice of the speech used to convey the advertisement may differ in pitch, tone, volume and/or voice.

In some embodiments, an introductory message announces the advertising message, including the source and/or subject of the message. In some implementations, the user provides an audible command via an input port on the mobile device that dictates an action to be taken on the advertising message, such as responding to the advertisement or requesting additional information regarding a promotional offer.

In another aspect, embodiments of the invention provide a system for presenting an audible representation of an advertising message delivered onto a mobile device. The system includes a processor for executing computer-executable instructions and a memory for storing the computer-executable instructions, that when executed by the processor implements a message and advertisement presentation application. The message presentation application presents an audible representation of the message and advertisement by receiving, at the mobile device, an incoming electronic message that includes textual content and a topic component, and translating the textual content to an audio stream. The application also electronically extracts the topic component and identifies advertisements stored in an electronic storage device having a matching topic component. An audible representation of the advertising message is injected into the audio stream of the incoming electronic message for presentation to the user. The advertising message and incoming electronic message emanate from different sources.

In some embodiments a central storage device stores the advertisements, each having at least one topic component. The electronic message can be an electronic mail message or a text message, and the topic can be any topic within a message, such as a geographical area, an activity, a product, a product class, or a service. In some embodiments, an introductory message may be injected into the audible representation of the advertising message. The tone and voice of the speech used to convey the advertisement may be the same as that of the electronic message, or, in some cases, may differ in pitch, tone, volume and/or voice.

In some embodiments, an introductory message announces the advertising message, including the source and/or subject of the message. In some implementations, the user provides an audible command via an input port on the mobile device that dictates an action to be taken on the advertising message, such as responding to the advertisement or requesting additional information regarding a promotional offer.

In another aspect, a method for delivering electronic advertisements includes audibly presenting a first set of electronic messages directed to a consumer, the first set being a subset of a collection of electronic messages directed to the consumer, audibly presenting an introduction to an electronic advertisement, audibly presenting a recitation of a subject of the electronic advertisement and audibly presenting the consumer with a call to action to receive additional details regarding the electronic advertisement. If an audible command from the consumer approving transmission of additional details regarding the electronic advertisement to the consumer is received, an electronic message related to the electronic advertisement to the consumer is initiated and a second set of electronic messages directed to a consumer is presented, where the second set is a subset of a collection of electronic messages directed to the consumer and distinct from the first set. If no such command is received within a predetermined time frame, a second set of electronic messages directed to a consumer is audibly presented, the second set being a subset of a collection of electronic messages directed to the consumer and distinct from the first set.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a diagrammatical illustration of a mobile communication device with an innovative Software Application, in accordance with embodiments of the present invention;

FIG. 2 is an illustration of a message list as may be presented on the display screen of the mobile communication device of FIG. 1;

FIG. 3 is an illustration of the message list of FIG. 2, including a microphone icon; and

FIGS. 4A, 4B, and 4C are flow diagrams illustrating operation of the mobile communication device of FIG. 1 while executing the Software Application in accordance with embodiments of the invention.

### DETAILED DESCRIPTION OF THE INVENTION

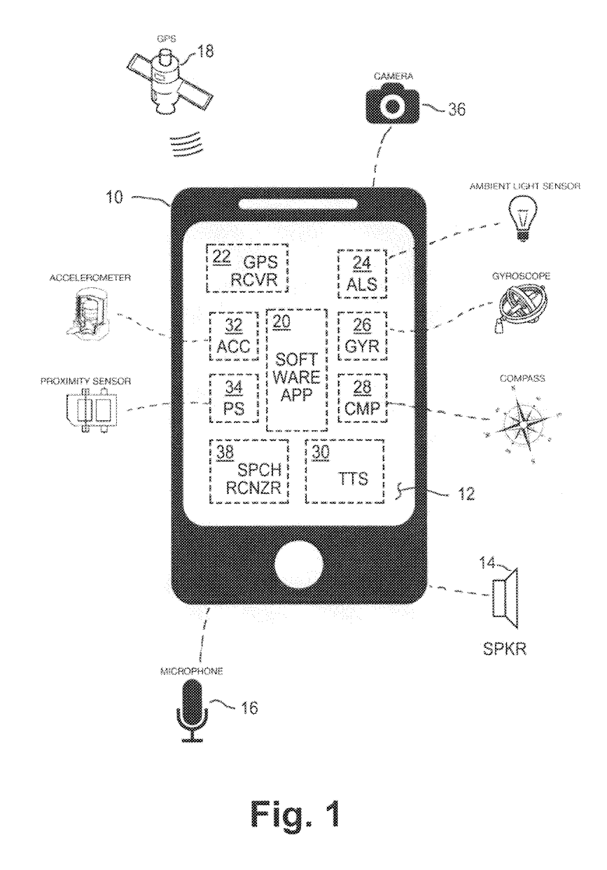

There is shown in FIG. 1 a mobile communication device 10, such as an IPHONE, a SMARTPHONE, an ANDROID, or a BLACKBERRY. The mobile communication device 10 may also include a cradle, a hook/pile fastener (not shown) or other physical mounting unit that supports and orients the mobile communication device 10 in view of the user. This configuration allows the user to operate the mobile communication device 10 in an essentially hands-off and eyes-free mode.

The mobile communication device 10 may include a Software Application 20, in accordance with an exemplary embodiment of the present invention. The Software Application 20 functions in conjunction with a speech recognizer 38 to enable the user to listen to and interact with the mobile communication device 10. In an exemplary embodiment, the user may interact with the mobile communication device 10 by selectively glancing at a display screen 12, listening to a speaker 14 in the mobile communication device 10, and providing verbal prompts to a microphone 16 in the mobile communication device 10.

A typical mobile communication device may include one or more internal sensors to enhance functionality and provide additional features to the user. For example, the mobile communication device 10 may include one or more of: (i) a GPS receiver 22 for receiving positioning signals from one or more GPS satellites 18, (ii) an ambient light sensor 24 for detecting ambient light conditions, (iii) a gyroscope 26 for detecting device rotation, (iv) a compass 28 for detecting device orientation, (v) an accelerometer 32 for detecting device movement, and (v) a proximity sensor 34 for detecting the presence of nearby objects. The mobile communication device 10 may also include a built-in camera 36 for obtaining digital images and/or video.

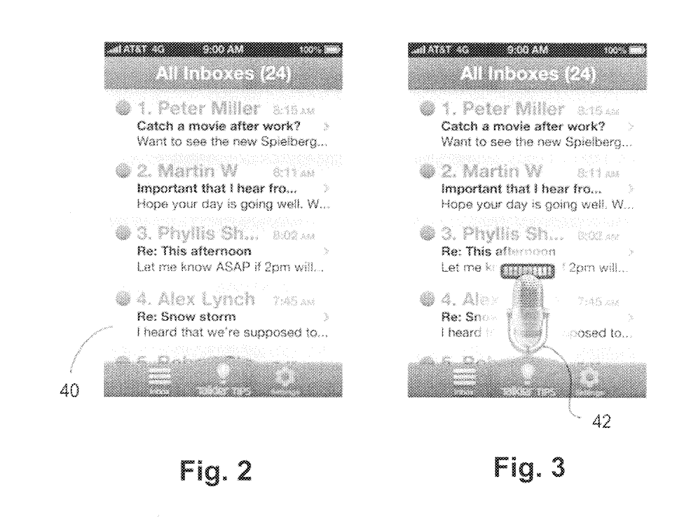

FIG. 2 shows a message inbox listing 40 as may be displayed in the display screen 12. In an exemplary embodiment, the Software Application 20 may function in conjunction with a text-to-speech (TTS) engine 30 and the speaker 14 to audibly inform the user of: (i) the time of receipt, (ii) the sender, (iii) the subject, and/or (iv) the body of an incoming e-mail message, other received communication, or advertisement, as described in greater detail below. As used herein, “messages” may refer to any content presented to a user, including, but not limited to an electronic mail message, a text message, an SMS message, a news story, a broadcast message, a calendar event description, a web page, a web-based article, a web log (blog), a weather report, a digital text document, a task from a task list, or other structured electronic content.

The TTS engine 30 and the speaker 14 thus operate in conjunction with a visual display on the display screen 12, where the visual display may incorporate teleprompter technology to provide a text display that is synchronized with the audio being generated by the TTS engine 30 and emitted by the speaker 14. As can be appreciated by one skilled in the art, text-to-speech technology may be inaccurate at times, and providing a synchronous teleprompter display in this manner allows the user to view words, such as proper names, which the text-to-speech technology might be mispronouncing. The user needs only to selectively glance at the text display in the display screen 12, and is thus not required to continually view the mobile communication device 10.

For example, the mobile communication device 10 may output, via the speaker 14, an audio statement such as “You have an unread message from Peter Miller, received at 8:15 AM.” A microphone icon 42 may appear in the message inbox listing 40, as shown in FIG. 3, to indicate that the Software Application 20 is ready to accept vocal instructions from the user. The mobile communication device 10 may also be directed by the user to “read out loud” the body of a selected message in the message inbox listing 40. If the user has elected to have the selected message read, the TTS engine 30 converts a portion of the message text to audible speech, and the Software Application 20 displays the message text on the display screen 12 in synchronicity with the audio generated by the TTS engine 30.

In an exemplary embodiment, the display screen 12 presents the message text in oversized letters, in a high-contrast manner, so that the selected message can be viewed and comprehended quickly and safely. The scrolling movement of the message text on the display screen 12, is similar to the scrolling action of a teleprompter, and is synchronized to the voicing of the text by the TTS engine 30. The size and pace of the visual display on the display screen 12 are preferably made to allow the user to safely locate any questionable word or phrase on the display screen 12, moments after the unclear word or phrase has been voiced by the TTS engine 30.

Additional features of these aspects of the invention are further described in co-pending patent application Ser. No. 13/921,586, the entire disclosure of which is incorporated herein by reference.

In the process of having the mobile communication device 10 read messages, the Software Application 20 may also function to read audio advertisement clips in the same TTS voice that is used to read the conventional e-mail messages (or other content text-based content) received by the user. This feature makes it unlikely that the user will “tune out” an audio advertisement clip, since the advertising material is being read to the user in the same TTS voice used for the reading of e-mail messages.

Accordingly, as the user pays attention to conventional e-mail messages, the user is likely to continue paying attention when a subsequent advertisement is read in the same TTS voice. The content itself (i.e., the user's own e-mail messages) is of importance to the user. So the user can ignore neither the content nor the advertisements, all of which are delivered in such a way as to be audibly indistinguishable from each other, except by their meaning

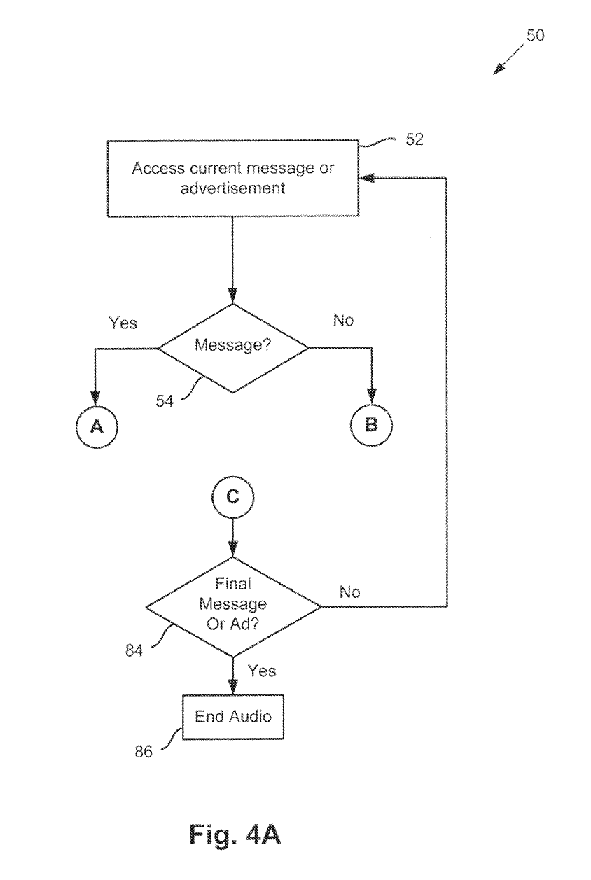

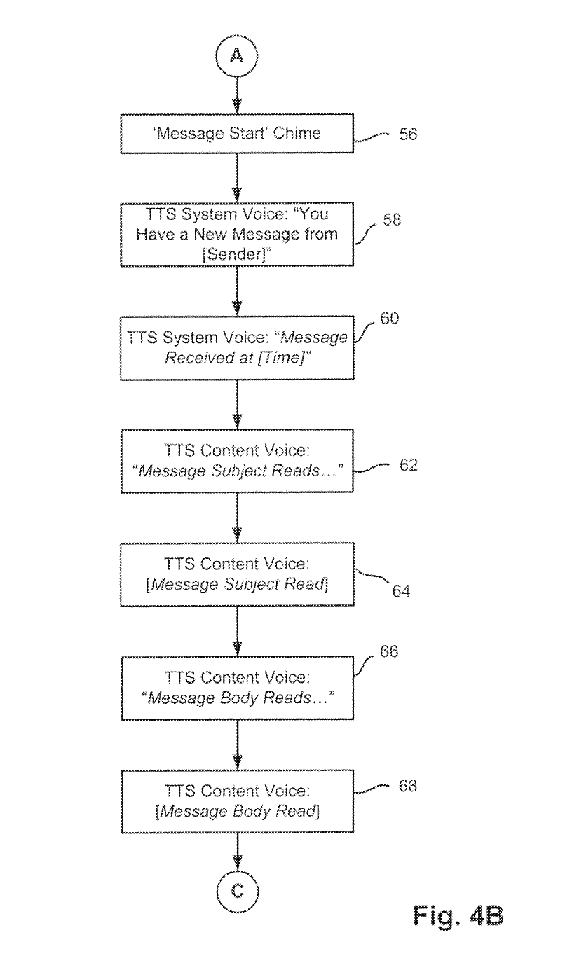

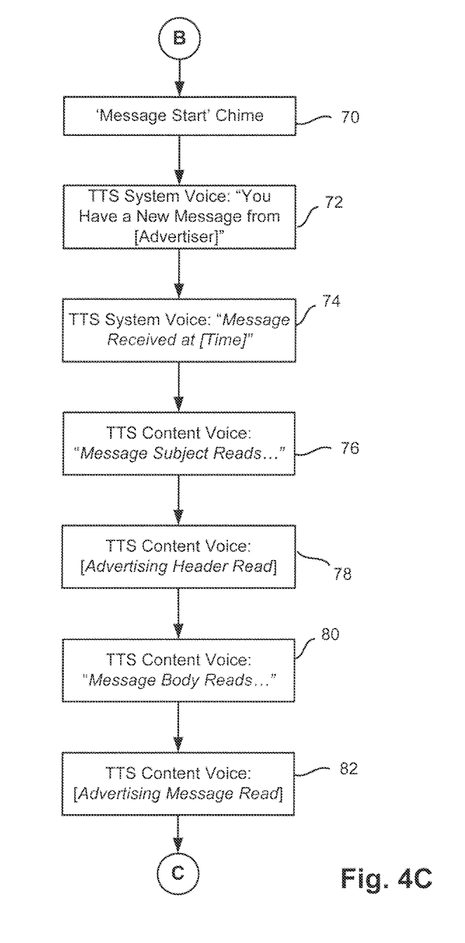

In an exemplary embodiment, described with reference to a flow diagram 50 in FIG. 4, the advertisement may be presented with the same syntactic structure and format as an e-mail message in the user's own inbox. Specifically, an advertisement voiced by the TTS engine 30 may begin with a time-received stamp and a sender, just as an e-mail message (for example, “You have an unread message from Staples, received at 8:15 AM”).

The Software Application 20 may access the current message or advertisement, at step 52. If a message is accessed, at decision block 54, the Software Application 20 generates a “message start” chime to inform the user of the playback of a new message, at step 56. The TTS engine 30 generates a system voice announcing “You have a new message from . . . ” and provides the name of the e-mail sender, at step 58. The TTS engine system voice then states the time of receipt of the message, at step 60.

The Software Application 20 may then inform the user of the subject of the message, at step 62, and may read out the subject line, at step 64. The TTS engine system voice may then state “message body reads,” at step 66, and may then read out the content of the message, at step 68. The process then continues to decision block 84 where a determination is made as to whether the current message is the final message to be read to the user. If there are additional messages to be read, the process returns to step 52. If no further messages remain, at decision block 84, the process may end for the time being, at step 86.

If an advertisement is accessed, at decision block 54, the Software Application 20 may also generate a “message start” chime to inform the user of the playback of a new “message,” at step 70. The TTS engine 30 generates a system voice announcing “You have a new message from . . . ” and provides the name of the advertiser, at step 72. The TTS engine system voice then states the time of receipt of the advertisement, at step 74.

The Software Application 20 may then inform the user of the subject of the advertisement, at step 76, and may read out the advertisement header, at step 78. The TTS engine system voice may then state “message body reads . . . ”, at step 80, and may then read out the advertisement, at step 82. The process then continues to decision block 84 where a determination is made as to whether the advertisement just read is the final “message.” If there are additional items in the Inbox to be read, the process returns to step 52. If no further messages or advertisements remain, at decision block 84, the process may end, at step 86.

A further enhancement involves keeping the TTS engine 30 advertisements brief enough (approximately 10 to 15 seconds long) that the user is unlikely to turn his or her attention away from the advertisement toward something else, because the advertisement is expected to end momentarily, and the same TTS engine 30 voice is expected to begin reading an e-mail message from the user's own inbox (i.e., content of personal importance that cannot be ignored).

A further enhancement involves the Software Application 20 identifying “Messages of Particular Importance” to the user, based on such criteria and heuristics as: (i) message priority flag set; (ii) message marked as important; (iii) message subject or body contains phrases such as “Important” or “Urgent” or “Time Sensitive” or “Please Respond”; (iv) message sender is one that user frequently reads; (v) message sender is one that user infrequently discards, (vi) message sender is one that user frequently forwards, (vii) message sender is one that user frequently replies to; or (viii) message sender's e-mail address is the same domain as the user's and is not a common publicly available domain such as gmail.com or mac.com (hence, the message sender may be a member of the same organization as the user).

In an exemplary embodiment, the Software Application 20 may announce to the user that a Message of Particular Importance, from a particular person, is available. But first, the Software Application may present a “brief message” from an advertising sponsor (so that the user pays particular attention during the “cliffhanger”). For example, the mobile communication device 10 may output, via the speaker 14, an audio statement such as “You have an important message from Peter Miller. But first, a brief message from Staples Office Stores . . . .”

In a variation, the Software Application 20 may interrupt the body of a particularly important message with an advertisement, after voicing the first sentence of the message (so that the user is aware of the urgency of the message). For example, the mobile communication device 10 may output, via the speaker 14, the first sentence of the body of the message, such as “I'm writing to warn you that we have changed the agenda for today's meeting.” Then the Software Application 20 may interrupt with an advertisement, such as “This email will continue in a moment, after a brief message from Staples Office Stores . . . .”

In an alternate embodiment, the body of a message may be interrupted with an advertisement that is of relevance to the current message being played back. For example, the Software Application 20 may have determined that the current message includes a particular topic content such as discussion of a proposed location for a meeting, social event, destination or product. The Software Application 20 may have reached this conclusion based on key phrases in the current message, such as: (i) “I suggest we meet at . . . ”; (ii) “how about [place name]”; (iii) city names; (iv) restaurant brand names; (v) destination names; (vi) driving directions; or (vii) URL to a map (e.g., Google Maps).

Upon identifying such a message, the Software Application 20 may interrupt the current message and announce that the remainder of the message will be read shortly, but that there will first be a brief announcement from an advertising sponsor. The Software Application 20 may deliver a “message” from a merchant, which merchant may have a retail location or physical presence nearby the proposed meeting location. In certain cases, the topic identified from the message may be used to match against metadata or other data associated with advertisements. For example, the mobile communication device 10 may output, via the speaker 14, a part of the body of the message, such as “I suggest we meet at the Staples on Main Street.” Then the Software Application 20 may interrupt with an advertisement, such as “This email will continue in a moment, after a brief message from Staples Office Stores . . . .”

This same concept may be applied to other types of relevant advertising, beyond simply geographic proximity, such as: (i) a message that discusses movie titles might be interrupted by an advertisement for a movie theatre chain or a specific movie; (ii) a message that discusses dining might be interrupted by an advertisement for a restaurant chain; or (iii) a message that discusses travel might be interrupted by an advertisement for a hotel chain, or airline.

The methods described above greatly improves the effectiveness of digital ads delivered to mobile devices as they are more difficult to “tune out” or disregard. Specifically, the ads are “sandwiched” within the user's own mission-critical emails or other mission-critical personal content and are relatively short (e.g., 10-15 seconds in length), thus the user knows a new critical message will be following very shortly. Moreover, because the same text-to-speech component may be used for the ads as well as the user content, the ads are delivered in such a way that they are difficult to distinguish audibly from the surrounding mission-critical email messages or other mission-critical audio content. Again, the ads are presented in the same or similar structure as the message and may be inserted directly into the body the message. For example, the system may “tease” the user with the first sentence of an email message identified as a “Message of Particular Importance” to the user via the methods described herein, and then insert an advertisement before delivering the remainder of the important email message.

In other implementations, the techniques and systems facilitate the simplified, safe, hands-free and eyes-free response to an audible advertisement in a manner consistent with the hands-free and eyes-free format of the audible advertisement itself. Such implementations address certain public safety problems for users who are driving while using the system, or who would be unable to respond to a conventional onscreen advertisement by tapping or clicking because their eyes or hands are otherwise occupied. Such implementations also promote dramatically higher click-through rates to benefit the advertisers, because upon conclusion of the audible advertisement, the system's TTS voice explicitly instructs the user how to respond. For example, upon conclusion of an audible advertisement, the system TTS might voice the following: “Say ‘send me details’ to get all the details emailed to you.” The system sounds an audible chime indicating that the system is listening for a voice command from the user. The system waits a specified number of seconds for the “Send me details” voice command from the user, and proceeds to playing the next message if no such voice command is received. As in this example, by pairing voice recognition (voice command speech technology) with audio advertisements and promotional content, the system allows the addition of an audible instruction from the system to the user, delivered by the TTS engine or prerecorded voice message, at the conclusion of each advertisement, to speak the command “Send me details.” The user may then audibly or via touch input a command to receive additional details about the offer. In some instances the instruction is provided by the system (say “yes” to receive additional details). In other instances, the user may interrupt the ad by pausing the voicing of the ad, and then issue a voice command such as “Send me details.” In other instances, the system may send details to the user by default, unless the user opts out. For example, upon conclusion of the audible advertisement, the system might say, “If you don't wish to receive details of this offer via email, simply say, ‘No, thank you.’” At this point, the system sounds an audible chime indicating that the system is listening for a voice command from the user. The system waits a specified number of seconds for the specified voice command from the user, and proceeds to playing the next message if no such voice command is received.

The Software Application 20 may be implemented on hardware such as a smart or dumb terminal, network computer, personal digital assistant, wireless device, smartphone, tablet, television, gaming device, music player, mobile telephone, laptop, palmtop, wireless telephone, information appliance, workstation, minicomputer, mainframe computer, or other computing device, that is operated as a general purpose computer or a special purpose hardware device that can execute the functionality described herein. The Software Application 20 may be implemented on a general purpose computing device in the form of a computer including a processing unit, a system memory, and a system bus that couples various system components including the system memory to the processing unit.

The described systems may include a plurality of software processing modules stored in a memory and executed on a processor in the manner described herein. The program modules may be in the form of any or more suitable programming languages, which are converted to machine language or object code to allow the processor or processors to read the instructions. The software may be in the form of a standalone application, implemented in any suitable programming language or framework.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories may store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

In various embodiments, the devices include a web browser, client application software, or both. The web browser allows the client to request a web page or other downloadable program, applet, or document (e.g., from the server(s)) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client manually requests a web page from the server. Alternatively, the device automatically makes requests with the web browser. Examples of commercially available web browser software are Microsoft® Internet Explorer®, Mozilla® Firefox®, and Apple® Safari®.

In some embodiments, the devices include client application software. The client application software provides functionality to the device that provides for the implementation and execution of the features described herein. The client application software may be implemented in various forms, for example, it may be in the form of a web page, widget, and/or Java, JavaScript, .Net, Silverlight, C++, C, Flash, and/or other applet or plug-in that is downloaded to the device and runs in conjunction with the web browser. The client application software and the web browser may be part of a single client-server interface; for example, the client software can be implemented as a “plug-in” to the web browser or to another framework or operating system. Any other suitable client software architecture, including but not limited to widget frameworks and applet technology may also be employed with the client software.

A communications network may connect the devices with one or more servers and/or with each other. The communication may take place via any media such as standard telephone lines, LAN or WAN links (e.g., T1, T3, 56 kb, X.25), broadband connections (ISDN, Frame Relay, ATM), wireless links (802.11, Bluetooth, GSM, CDMA, etc.), and so on. The network may carry TCP/IP protocol communications, and HTTP/HTTPS requests made by a web browser, and the connection between the clients and servers can be communicated over such TCP/IP networks. The type of network is not a limitation, however, and any suitable network may be used.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD-ROM, a CD-RW, a CD-R, a DVD-ROM, a DVD-RW, a DVD-R, a flash memory card, a PROM, a RAM, a ROM, or a magnetic tape. In general, the computer-readable programs may be implemented in any programming language. The software programs may be further translated into machine language or virtual machine instructions and stored in a program file in that form. The program file may then be stored on or in one or more of the articles of manufacture. In other cases the invention may take the form of a downloadable application made available in either a public or private application platform.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for presenting an audible representation of an advertising message delivered onto a mobile device, the method comprising the steps of:
receiving an incoming electronic message at the mobile device, the incoming message comprising textual content and at least one topic component;
translating the textual content to an audio stream;
electronically identifying the topic component and identifying one or more advertisements stored in an electronic storage device having a matching topic component;
interjecting an audible representation of the advertising message into the audio stream of the incoming electronic message, wherein the advertising message and incoming electronic message emanate from different sources.

2. The method of claim 1 wherein the electronic message comprises one of an electronic mail message, a text message, an SMS message, a news story, a broadcast message, a calendar event description, a web page, a web-based article, a web log (blog), a weather report, a digital text document, a task from a task list, or other structured electronic content.

3. The method of claim 1 wherein the topic component comprises one or more of a geographical area, an activity, a product, a product class, or a service.

4. The method of claim 1 further comprising interjecting one of an introductory message prior to the audible representation of the advertising message or a concluding message at or near the end of the audible representation of the advertising message.

5. The method of claim 4 wherein the introductory message announces the source of the advertising message.

6. The method of claim 4 wherein the introductory message announces the subject component of the advertising message.

7. The method of claim 4 further comprising receiving an audible command from a user of the mobile device wherein the command dictates an action to be taken on the advertising message.

8. The method of claim 7 wherein the audible command comprises one of a command to be sent additional details regarding the advertisement.

9. A system for presenting an audible representation of an advertising message delivered onto a mobile device, the system comprising:
a processor for executing computer-executable instructions; and
a memory for storing the computer-executable instructions, that when executed by the processor implements a message and advertisement presentation application, wherein the message presentation application presents an audible representation of the message by:
receiving an incoming electronic message at the mobile device, the incoming message comprising textual content at least one topic component;
translating the textual content to an audio stream;
electronically identifying the topic component and identifying one or more advertisements stored in an electronic storage device having a matching topic component;
interjecting an audible representation of the advertising message into the audio stream of the incoming electronic message, wherein the advertising message and incoming electronic message emanate from different sources.

10. The system of claim 9 further comprising a storage device for storing a plurality of advertisements, each having at least one topic component.

11. The system of claim 9 wherein the electronic message comprises one of an electronic mail message, a text message, an SMS message, a news story, a broadcast message, a calendar event description, a web page, a web-based article, a web log (blog), a weather report, a digital text document, a task from a task list, or other structured electronic content.

12. The system of claim 9 wherein the topic component comprises one or more of a geographical area, an activity, a product, a product class, or a service.

13. The system of claim 9 further comprising interjecting one of an introductory message prior to the audible representation of the advertising message or a concluding message at or near the end of the audible representation of the advertising message.

14. The system of claim 13 wherein the introductory message announces the source of the advertising message.

15. The system of claim 13 wherein the introductory message announces the subject component of the advertising message.

16. The system of claim 13 further comprising receiving an audible command from a user of the mobile device wherein the command dictates an action to be taken on the advertising message.

17. The system of claim 16 wherein the audible command comprises one of a command to be sent additional details regarding the advertisement.

18. A method for delivering electronic advertisements, the method comprising:
audibly presenting a first set of electronic messages directed to a consumer, the first set being a subset of a collection of electronic messages directed to the consumer;
audibly presenting an introduction to an electronic advertisement;
audibly presenting a recitation of content of the electronic advertisement;
audibly presenting the consumer with a call to action to receive additional details regarding the electronic advertisement;
upon receiving an audible command from the consumer approving transmission of additional details regarding the electronic advertisement to the consumer: (i) initiating an electronic message related to the electronic advertisement to the consumer and (ii) audibly presenting a second set of electronic messages directed to a consumer, the second set being a subset of a collection of electronic messages directed to the consumer and distinct from the first set, or, if no such command is received within a predetermined time frame, audibly presenting a second set of electronic messages directed to a consumer, the second set being a subset of a collection of electronic messages directed to the consumer and distinct from the first set.
